(19) United States
(12) Patent Application Publication
(10) Pub. No.: US 2013/0007657 A1
(43) Pub. Date: Jan. 3, 2013

(54) METHOD FOR QUICK RESPONSE ICONIC TAGS ON OFFLINE SIGNAGE, DOCUMENTS AND VISUAL MEDIA

(75) Inventor: Alexander Raymond Gammill, Austin, TX (US)

(73) Assignee: Mr. Alexander Raymond Gammill, Austin, TX (US)

(21) Appl. No.: 13/172,802

(22) Filed: Jun. 29, 2011

(51) Int. Cl. G06F 3/048

(52) U.S. Cl. 715/810

(57) ABSTRACT

This invention discloses an improved method for tagging (10) offline signage, documents or visual media (11) with an iconic identifier (13) consisting of icons (14), symbols and alphanumeric characters (17) in various combinations next to a logo (12) of a hub website or application (21) where the tag's (10) iconic identifier (13) can be manually entered into a field (20) by a user on the hub (21) so that the user can be directed (30) quickly to a webpage (31) that the promoter desires. In this scenario, the iconic identifier (13) not only acts as a short code, but because icons (14) connote meaning, the iconic identifier (13) also functions as a marketing enhancement.

### BACKGROUND

1. Field of the Invention

This invention relates generally to marketing and QR (Quick Response) codes for finding information quickly, but more particularly, to providing an improved method for tagging offline signage, documents and visual media with iconic identifiers consisting of icons, symbols and alphanumeric characters for manual entry into a hub website or application by a user to retrieve additional information as if clicking an online link.

2. Description of Prior Art

Though we live in the computer age, offline signs—those not connected to the internet—still play an important role in society. Billboards advertise products or the location of a nearby store. Banners advertise upcoming events. Visual media like TV often advertise fundraisers or tips for crime reporting. “For Sale” signs hang on everything from cars to houses; and sometimes a handmade poster or document advertises a local garage sale or requests information on a missing cat. As different as all these offline displays are, each suffers from two common problems, 1) limited space, whereby all relevant information cannot be shown, and 2) an inability to quickly access specific information.

Limited space can be overcome if signage can point customers to more information like the internet, which is why many signs carry URLs as an indirect link to the internet. But not every event, such as a garage sale or lost cat, need URLs; and if an event does require one, URLs have become cumbersome and long. Moreover, requiring customers to enter bloated URLs on any computer, especially smart phones, wouldn't be ideal.

There are many URL shortening services. TinyURL.com is one, but its final URL is still rather lengthy in that the client must enter “tinyurl.com” followed by more alphanumeric characters. Another URL shortening service, Bit.ly.com, offers direct URL entry such as pep.si that directs users to pepsi.com; but Bit.ly advocates permanent links, which favors general information and not specifics. Actually, many business now use social media such as Facebook or Twitter, whose logos are followed by a name such as twitter@Sony or the actual twitter logo followed by @Sony, to provide general information to their customers. Nonetheless, if Sony sponsored a fun run in one city, interested people would be directed to the main site where they would be required to search for specifics. Moreover, promoters who would simply like to place signage on a boat for a weekend sale, wouldn't want to create a whole new website or create a new social media account just to promote the one sale. Signage such as these could benefit from the internet by displaying more information such as a free Craigslist ad or a free Google document. The problem again is that internet documents and ads have bloated URLs.

Another method to point customers to specific information is through the use of QR codes—similar to bar codes, except square. QR codes are now found in magazines, advertisements and small property signs; but QR codes require customers to download special software on smart phones to take pictures or scan the code in. More problematic, QR codes aren't ideal for scanning from billboards, TV ads, or when potential customers ride by in passing cars. If someone wants more info, but their smart phone is in the other room, memorizing a barcode would be impossible. Even though QR codes are popular in Japan, they haven't been as successful in the United States.

A more memorable approach would be the use of alphanumeric codes. U.S. Pat. No. 6,853,979 issued to Bass (2005), discloses a method of marketing goods and services in which a physical “For Sale” sign includes a unique identifier and the website address of a common advertising website. Potential customers can access an online advertisement associated with the sign by logging onto a common advertising website by entering the unique identifier, preferably alphanumeric characters of six or less characters in length. Though the Bass patent's claim doesn't specify the exact nature of the unique identifier in the claim itself, it does so in the drawings and in the summary of the invention, showing alphanumeric identifiers, which is understandable since alphanumeric characters and keyboard symbols are the standard method for manually entering identification codes. Similar to the Bass patent, U.S. Patent Application Publication 2002/0087420, to Higgins et al. (2002), U.S. Pat. No. 6,898,571 to Val et al. (2005), and U.S. Patent Application Publication 2007/0233662, to Bashardoost et al. (2007) all disclose various methods for utilizing a common website and manually entering alphanumeric identification codes. The Higgins application uses telephone numbers and character strings as identification codes. The Val et al. patent discloses a unique alphanumeric cue codes as identification codes, and the Bashardoost application discloses an alphanumeric identification code that is differentiated by other factors, such as location, so that the same alphanumeric identification code can be used more than once. Unfortunately, by allowing the same identification code to be used multiple times, it requires users to search further, after an initial search, to find the correct listing thereby increasing search time. Moreover, all of the cited examples prefer a common website of a service provider that returns information housed on the service provider's website. What if a promoter didn't want to be limited by that layout or be required to use the service provider's landing page? If an ad is already created on Craigslist, why would someone want to recreate this ad on a service provider's website just to point to the Craigslist ad? And what if the promoter simply wants to link to a video or a Google map? The promoter would have to create a second ad or webpage on the service provider's site just to get to the final destination.

Still, in order for alphanumeric identification codes to be memorable, they should be short. The total combinations and permutations of up to four alphanumeric characters (A-Z and 0-9) is 1,727,604. If a website could accept symbols as well, that would increase the combinations. For example, just adding three symbols as options for an identification code of up to four or less entries would increase the total available options to 2,374,320. But, alphanumeric characters and symbols aren't as eye catching as icons.

U.S. Pat. No. 7,003,736 to Dimitri Kanevsky et al. (2006) discloses iconic representation of content that is determined by the content of the files to help with searches; but this system is reversed to what is needed for offline signage, which is a way to find the icons in an identification code by way of direct manual entry of icons. The main problem with icons as identification codes is that they cannot be entered with standard keyboards; and search engines rarely recognize or accept icons, unless they are specialized to do so, like reverse image lookups; but even those return only the location of the target image and do not attempt to look for group sets of icons, symbols and alphanumeric characters as identifiers. Microsoft Word allows symbols and a few icons to be entered like character fonts and searched, but users have to sift through several fonts in order to find the correct symbol or icon, and if the user lacks the correct font software, they cannot see the symbols or icons. The internet site new.myfonts.com, recently came up with GUI-design-icons (http://new.myfonts.com/fonts/upir-typo/gui-design-icons/gallery.html) that can combine icons to create various combinations, but this tool is geared for graphic artists to create icons for websites or to make their own specialized icon font by using pre-stylized icons. Combining the pre-stylized icons requires an graphic artist-like tool that moves the icon to the correct position and does not allow quick entry of icons through an entry field, which is beyond its scope of simply creating icons.

There is still a need for offline signage to have short code-like tags that are memorable, eye catching, and can be quickly and simply entered into a field without the need for specialized tools or additional searching. More importantly, the tags should allow for numerous combinations and have the ability to work as a marketing enhancement as well.

### Objects and Advantages

Accordingly, several objects and advantages of the present invention for providing a method for tagging offline signage, documents or visual media with iconic identifiers consisting of icons, symbols and alphanumeric characters that can be entered manually as an identifier on a hub website or application are:
a) icons provide more meaning in less space than common alphanumeric characters, allowing the iconic identifier to have a dual function as both short identifier and marketing component;
b) short identifiers are memorable, allowing customers to enter identifiers at a later time;
c) short identifiers can be enlarged bigger than bloated URLs, allowing the short identifier to be seen at a greater distance, ideal for outdoor signage;
d) a hub allows users to input iconic identifiers from a selection menu without requiring the need for specialized keyboards;
e) having an option for background icons provides more combinations for short iconic identifiers and reduces the space requirement on a menu because all possible configurations would not be required to be displayed on the menu;
f) having an option for formatting iconic identifiers with underlining or fraction-like displays would also provide more combinations; and,
g) promoters would have another creative and eye catching tool to drive traffic quickly and efficiently to specific webpages of their choosing.

Additional objects and advantages will become apparent from a consideration of the drawings and ensuing descriptions.

### BRIEF DESCRIPTION OF DRAWINGS

FIG. 1 is a diagram of the method.

FIG. 2 discloses a hub example.

FIG. 3 discloses methods for entering iconic identifiers.

Reference Numerals in Drawings

| | |
|---|---|
| 10 tag | 11 offline signage, document or visual media |
| 12 hub logo | 13 iconic identifier |
| 14 icons | 15 background icons |
| 16 formatting icons | 17 symbols or alphanumeric characters |
| 20 manual entry | 21 hub website or application |
| 22 navigation keys | 23 selection menu |
| 30 URL direction | 31 landing page |

### SUMMARY

This invention discloses an improved method for tagging 10 offline signage, documents or visual media 11 with an iconic identifier 13 consisting of icons 14, symbols and alphanumeric characters 17 next to a logo of a hub website or application 12 where the tag's 10 iconic identifier 13 can be manually entered 20 into a field by a user on the hub 21 so that the user can be directed 30 quickly to wherever the promoter of the sign wishes to direct the user 31. This method allows the iconic identifiers 13 to function as both short codes and informative marketing enhancements. But for icons 14 to be practical elements in any identification entry 20, they need to be available for selection by a user for entry 20 and each icon 14 should be distinct and discernable so that the user doesn't confuse them with other icons 14. In addition to standalone icons 14 as an iconic identifier 13, by allowing some icons 14 to function as background icons 15—to be placed behind other iconic identifiers 13 or behind individual elements within an iconic identifier 13—it would create a new iconic identifier 13. More importantly, each iconic identifier 13 would not require exact representation on a selection menu 23 because the iconic identifier 13 is created during manual entry 20. For example, the following icon [symbol] of a number one inside a circle commonly requires that the exact representation appears on a selection menu 23 for manual entry 20. Thus the numbers one through ten would require ten separate icons 14 on the selection menu 23. However, by allowing a background icon 15 for selection, such as the circle , any symbol or alphanumeric character 17 with a circle background could be created by simply selecting the symbol or alphanumeric character 17 followed by a background icon 15. Other formatting techniques 16, such as underlining 16 various elements within an iconic identifier 13 or creating fraction-like 16 iconic identifiers 13 would create more iconic identifiers 13, exponentially increasing the possible variations.

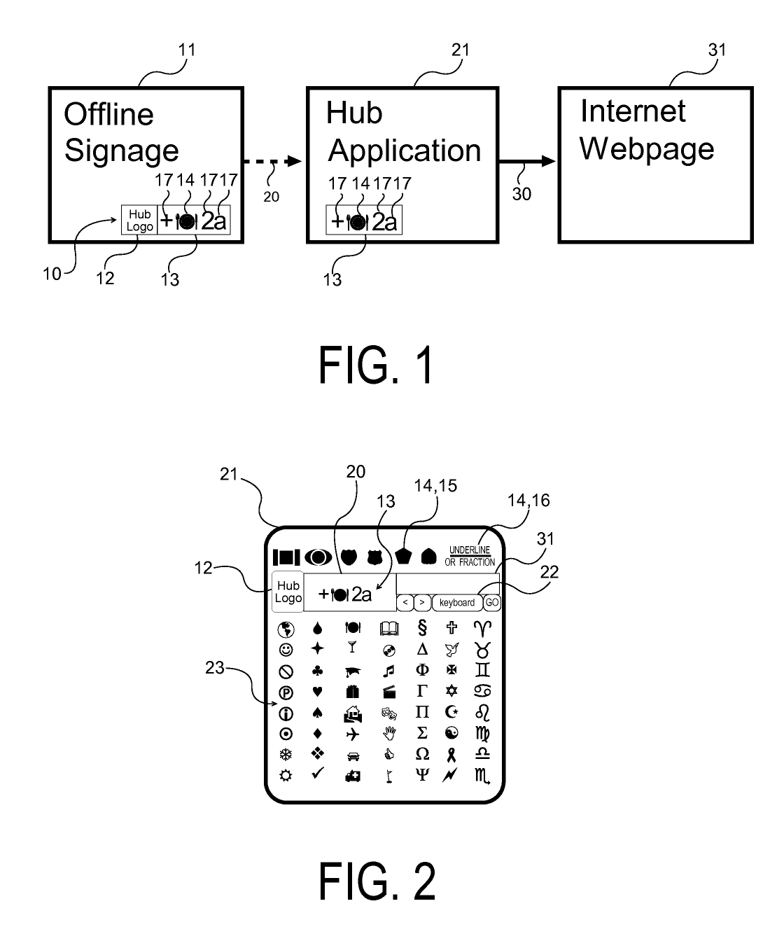

### Description—FIGS. 1 to 2

A typical representation of the present method is illustrated in FIG. 1., consisting of three main components: 1—offline signage 11, 2—a hub application 21, and 3—an internet webpage 31.

Offline signage 11 are signs that are not connected to the internet such as yard signs, banners, posters and flyers. Media that aren't connected to the internet can also benefit from the present invention such as television, magazines and newspapers. Any offline display 11 using the invention is required to show a tag 10 consisting of a hub logo 12 near an iconic identifier 13 which is further composed of icons 14, symbols and alphanumeric characters 17. Once a user sees a tag 10 and would like more information, they would need to go to the hub application 21 that ideally has access to the internet. The user would know of the hub application 21 because of the hub logo 12 associated with the tag 10.

The hub application 21 could be a smart phone app or a website that functions like an app where the user can manually enter into a field 20 an iconic identifier 13 of icons 14, symbols or alphanumeric characters 17 that appear as part of the tag 10. The field would accept manual entry 20 of icons 14 because the icons 14 would be visible for selection, which I will discuss in further detail in the next paragraph. Once the iconic identifier 13 is entered and matched by the hub application 21 to an iconic identifier 13 already assigned by a promoter of the offline signage 11, the hub application 21 would direct 30 the user to a webpage 31. The webpage 31 could be any landing page that the promoter wishes to direct 30 the user.

FIG. 2 discloses an example hub app 21 that would except iconic identifiers 13, including icons 14. Next to the hub logo 12 is the field for manually entering 20 the iconic identifier 13; and to the right of that is a field for displaying the link of the landing page 31 for the matched iconic identifier 13. Below that are navigation keys 22 for moving the curser inside the field for manual entry 20; and below that is the selection menu 23 showing icons 14 and symbols 17 available for entry, however many more icons 14 could be available for entry if one scrolled down. Ideally, similar icons 14 should be grouped together in the selection menu 23 for ease of finding.

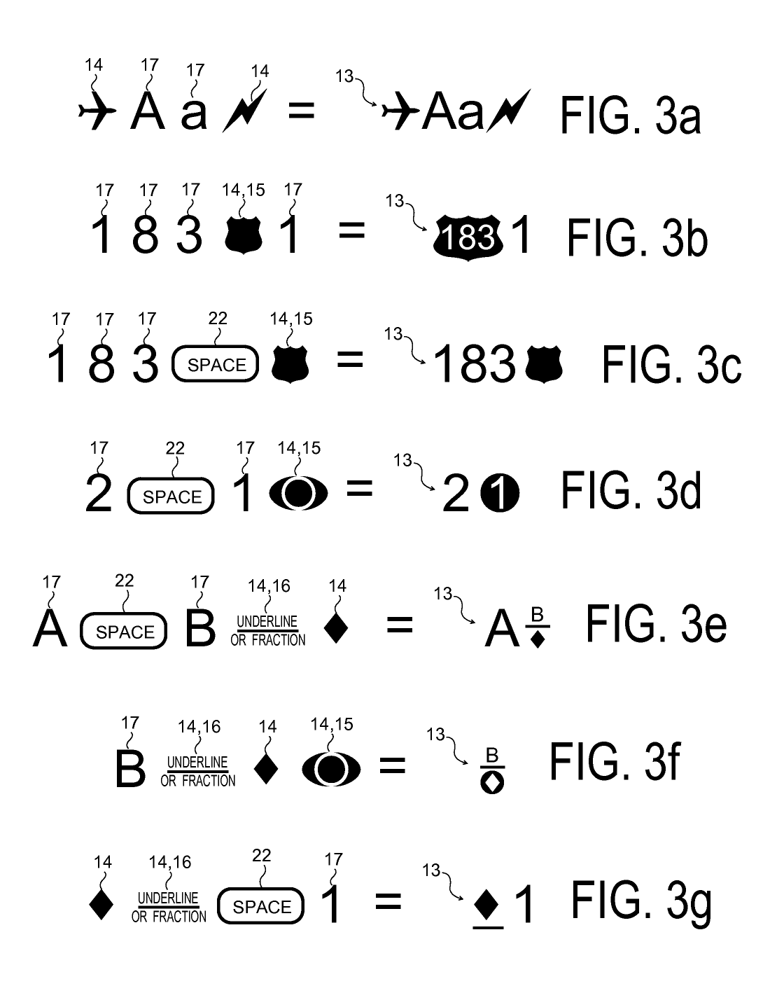

### Operation—FIGS. 2-3

The first requirement of the invention is for offline signage 11 to be tagged 10 with a hub logo 12 and icon identifier 13. Placing both on signage 11 is relatively simple in that the same entry method 20 for creating icon identifiers 13 to search can also be used to create icon identifiers 13 for production. Once the promoter creates an icon identifier 13 and registers its directing URL 30 on a hub 21 that stores the icon identifier 13 and its associated URL 30, the promoter can screen capture, print or save the tag as an image file or printout 10 to be placed on a sign 11.

When a customer sees the tagged 12 sign 11, the user can go to the hub website 21, unless they have the app 21 already on their smart phone in which case they would simply go to that. They would see a layout similar to FIG. 2. If the tag 12 had an icon 14, selecting or clicking the icon 14 from the selection menu 23, would place it into the entering field 20. Common symbols and alphanumeric characters 17 would not need to be displayed on the selection menu 23 because they can be entered in the common manner of a keyboard, display or other input device.

What differentiates this invention is that it allows icons 14 to be easily entered and searched (which can be done by assigning icons 14 with character strings or values so that the hub 21 can find the icon 14 while only displaying the icon 14 and not its code behind) thereby significantly increasing the available combinations for promoters. However, if there are too many icons then users would waste time searching for icons on the selection menu 23, defeating the purpose of a quick response method. During my rendering of the invention, an unexpected result occurred when some icons 14 were allowed to function as background icons 15. It would more than double the possible combinations without the need to create representative icons 14 on the selection menu 23 because the background icon 15 functioned as both a normal icon 14 or as a background icon 15, placed behind other icons 14, symbols or alphanumeric characters 17, which in itself creates a new icon 14. For example, the interstate shield icon 14,15 [symbol] could be used alone [symbol] or placed behind a number, such as thirty-five, which the hub 21 would format white, to create the 135 interstate symbol [symbol] . Thus we have a new distinct and discernable icon 14 that was entered through simple manual entry 20, more about this in the next paragraph. If more symbols or alphanumeric characters 17 are entered, such as three hundred, the hub 21 would format the elements by stretching the width of the background and reduce the size of the number to fit, thereby creating a new distinct and discernable icon 14. Combining background icons 15 with icons 14 and symbols and alphanumeric characters 17 should not be limited to a mere placement of one behind the other, but should be formatted for clarity and proper contrast, much the same way that bolding a font can enhance a font's appearance. With this method, numerous formatting 16 possibilities exist such as underlining, creating fractions or changing colors; and all of this done through simple manual entry 20.

FIGS. 3a-3g show example entry methods for creating iconic identifiers 13. By using navigation keys 22, along with a keyboard, icons 14, background icons 15 and formatting icons 16, a user can manually enter 20 the example iconic identifiers 13 shown, where the entered elements 14,15,16,17 are shown to the left of the equal sign and the resulting iconic identifier 13 is shown to the right. FIG. 3a shows an iconic identifier 13 that is created by selecting icons 14 from the selection menu 23 and alphanumeric characters 17 from another input device such as a keyboard. FIG. 3b shows an iconic identifier 13 created by selecting alphanumeric characters 17 followed by a background icon 15, which is followed by an alphanumeric character 17. FIG. 3c shows how the navigation key space bar 22 can be used to designate where icon backgrounds 14,15 start and end on the iconic identifier 13. FIG. 3d shows another variation of an iconic identifier. FIG. 3e shows an iconic identifier 13 that uses the formatting icon 16, and in this example creates a fraction-like icon 14,16. FIG. 3e shows an iconic identifier 13 that combines the background icon 14,15 with the formatting icon 14,16. FIG. 3g shows an iconic identifier 13 that uses the formatting icon 14,16 to create an underlined icon 14.

### CONCLUSIONS, RAMIFICATIONS, AND SCOPE

This patent discloses a method for tagging 10 offline signage 11 with icons 14, symbols and alphanumeric characters 17 to create iconic identifiers 13, providing promoters with many ways to use and benefit from this invention. Billboards 11 often give directions to nearby stores. By using a short tag 10 on a billboard 11, a potential customer could enter the iconic identifier 13 on the hub 21 and be directed 30 to a Google map 31 that pinpoints the store's location with the customer's current location, making it easy for the customer to find the store. Specific franchise locations could promote deals only available for that particular store by directing 30 customers to their specific page 31 as opposed to the main franchise page. Movie theater signage 10 could direct 30 customers to a times page 31 for that particular location rather than sending them to the main page for all the theaters where the customer has to search again for their particular location.

Perhaps someone wants to sell a car and they create a Craigslists ad 31. By placing a short tag 10 on the car, the hub 21 could direct 30 customers to the Craigslist ad 31 where they could see more features and information. Property owners could direct 30 customers to specific listings 31 rather than a main site where the customer would need to search for the appropriate address. Teenagers could wear t-shirts 10 to promote 30 their own Facebook page 31 or perhaps direct 30 people to a fundraiser 31. Cities that advertise with banners 11 could direct 30 citizens to specific information about an upcoming event 31. A newscast 11 about an amber alert, could direct 30 people to specifics 31 without the need to visit their site and dig through more pages.

Because the possibilities for using this method are endless, tags 10 should allow for numerous variations, which this patent has disclosed through the use of icons 14 and their equivalents as backgrounds 15 and various formats 16, all through simple manual entry 20. Though these descriptions contain many specificities on how the invention may be practiced and is described in sufficient detail to enable those skilled in the art to practice the invention, the scope of the invention should be determined by the appended claims and their legal equivalents.

I claim:

1. A method for tagging offline signage comprising:
a plurality of icons that are distinct and discernable by users;
a hub website or hub application that can store said icons, and various combinations therein, with associated hyperlink information for each said icon or icon combinations;
at least one logo of said hub to be placed on said signage;
at least one or more said icons near said logo; and,
a field for entry on said hub where said user can manually enter said icons of said signage so that said hub can search said entered icons with said stored icons for an exact match to retrieve said associated hyperlink and direct said user to the webpage of said associated hyperlink.

2. The method of claim 1 wherein said signage are offline documents.

3. The method of claim 2 wherein said signage are offline visual media.

4. The method of claim 3 wherein said icons are combined with symbols or alphanumeric characters.

5. The method of claim 4 wherein some icons are also background icons that appear behind other said icons, symbols or alphanumeric characters to create new icons which together are also distinct, discernable and searchable.

6. The method of claim 5 wherein formatting said icons by underlining various icons creates new icons which are also distinct, discernable and searchable.

7. The method of claim 1 wherein said hub displays a menu of said icons for said user to select for said entry into said entry field.

8. A method for tagging offline signage comprising:
a plurality of icons, symbols and alphanumeric characters that are distinct and discernable by users wherein some icons can be background icons that appear behind other said icons, symbols or alphanumeric characters;
a hub website or hub application that can store said icons, symbols and alphanumeric characters together, or in various combinations therein, as an iconic identifier wherein each said iconic identifier can be assigned hyperlink information;
at least one logo of said hub to be placed on said signage;
at least one said iconic identifier near said logo containing at least one said icon; and,
a field for entry on said hub where said user can manually enter said icons, symbols and alphanumeric characters of said signage as a said iconic identifier so that said hub can search said entered iconic identifier with said stored iconic identifiers for a match to retrieve said assigned hyperlink and direct said user to the webpage of said assigned hyperlink.

9. The method of claim 8 wherein said signage are offline documents.

10. The method of claim 9 wherein said signage are offline visual media.

11. The method of claim 10 wherein formatting said iconic identifiers by underlining various elements of said iconic identifiers creates a new iconic identifier which is also distinct, discernable and searchable.

12. The method of claim 11 wherein said hub displays a menu of said icons for said user to select for said entry into said entry field.

13. A method for tagging offline signage comprising:
a plurality of icons, symbols and alphanumeric characters that are distinct and discernable by users;
a hub website or hub application that can store said icons, symbols and alphanumeric characters together, or in various combinations therein, as elements of an iconic identifier so that each said iconic identifier can be assigned hyperlink information;
at least one logo of said hub to be placed on said signage;
at least one said iconic identifier near said logo;
at least one or more said elements of the iconic identifier to be a said icon; and,
a field for entry on said hub where said user can manually enter said icons, symbols and alphanumeric characters of said signage as an iconic identifier so that said hub can search said entered iconic identifier with said stored iconic identifiers for a match to retrieve said assigned hyperlink and direct said user to the webpage of said assigned hyperlink.

14. The method of claim 13 wherein said hub displays a menu of said icons for said user to select for said entry into said entry field.

15. The method of claim 14 wherein formatting said iconic identifier places background icons behind various said elements of said iconic identifier to create new iconic identifiers which are also distinct, discernable and searchable.

16. The method of claim 14 wherein formatting said iconic identifier creates two iconic identifiers, one above the other and separated by a line, thereby creating one new iconic identifier which is also distinct, discernable and searchable.

17. The method of claim 14 wherein formatting said iconic identifier underlines various said elements of said iconic identifier thereby creating new iconic identifiers which are also distinct, discernable and searchable.
